(19) United States
(12) Patent Application Publication
(10) Pub. No.: US 2010/0001438 A1
(43) Pub. Date: Jan. 7, 2010

(54) PROCESS FOR PRODUCING MICROFIBER ASSEMBLY

(75) Inventor: Yoshinori Kishimoto, Kochi (JP)

Correspondence Address: HESLIN ROTHENBERG FARLEY & MESITI PC, 5 COLUMBIA CIRCLE, ALBANY, NY, 12203, US

(73) Assignee: Hirose Seishi Kabushiki Kaisha, Kochi (JP)

(21) Appl. No.: 12/374,513

(22) PCT Filed: Nov. 30, 2006
(86) PCT No.: PCT/JP2006/323922

§ 371 Date: Jan. 21, 2009

(30) Foreign Application Priority Data
Jul. 21, 2006 (JP) 2006-199179

(51) Int. Cl. B29C 47/00

(52) U.S. Cl. 264/465

(57) ABSTRACT

A process for producing a fiber assembly or agglomerate requiring micropores, such as for a battery separator or any of various filters, which is performed by electrostatic spinning and provides high productivity and ease of maintenance, is provided. The process for producing a microfiber assembly or agglomerate by electrostatic spinning includes continuously forming bubbles on a polymer solution or a polymer melt and applying high voltage to the formed bubbles. The bubbles can be formed by passing compressed air through porous material of one or a combination of two or more of plastic, ceramic and metal materials, or capillaries.

### CROSS REFERENCE TO RELATED APPLICATIONS

This application is a national stage filing under section 371 of International Application No. PCT/JP2006/323922, filed on Nov. 30, 2006 and published in Japanese on Jan. 24, 2008, as WO 2008/010307, and which claims priority of Japanese application No. JP 2006-199179, filed on Jul. 21, 2006, the entire disclosure of these applications being hereby incorporated herein by reference.

### TECHNICAL FIELD

The present invention relates to a process for producing microfiber assembly or agglomerate by electrostatic spinning or electrospinning that provides high productivity and ease of maintenance.

### BACKGROUND ART

Fiber assemblies and agglomerates, typically nonwoven fabrics and the like, have been applied to such as battery separators and filters, making good use of the micropores. The requirements for the size of the micropores vary depending upon the fields where they are applied to. For example, nickel metal hydride battery separators require micropores having a diameter of 1 to 30 μm, while lithium-ion battery separators require micropores having a diameter of 0.1 to 1 μm. Especially, since lithium-ion secondary batteries can provide high energy density and a future demand for them can be expected, for lithium-ion secondary battery separators as well, an important technical challenge is required to ensure the reliability of micropore control.

It is known that the size of micropores of a fiber assembly or agglomerate is substantially affected by the size of fibers making up the fiber assembly. More specifically, the formation of smaller micropores requires the production of fiber agglomerate by using fibers having a smaller fiber diameter. To obtain fiber agglomerate having submicron micropores such as for lithium-ion secondary battery separators, microfibers having a submicron fiber diameter need to be used.

Electrospinning is known as a process for preparing a fiber agglomerate made of submicron microfibers. In this process, when a polymer solution or a polymer melt is extruded from spinning nozzles, a high voltage of 0.5 to 30 kV is applied between spinning nozzles and a counter electrode to accumulate electric charges in the dielectric in the nozzles, and their electrostatic repulsive force is used to produce microfibers.

When the microfibers are output from the spinning nozzles, the electrostatic repulsive force makes the polymer microscopic, resulting in the formation of nanoscale microfibers. At this point, the solvent in which the polymer is dissolved is released out of the fibers, and deposited microfibers contain almost no solvent. Therefore, since almost dry fiber agglomerate is formed immediately after spinning, it can be said that this process is an extremely simple process for producing a microfiber agglomerate.

In addition, electrospinning basically allows spinning of any polymer if the polymer can be converted into a solution, and has the advantage of being applicable to many types of polymers. Moreover, hollow microfibers and microfibers having a core-sheath structure can also be prepared by preparing a polymer solution with two or more polymers mixed and then spinning the solution or devising the spinning nozzles.

An advantageous feature of electrospinning for practical use is that it easily allows microfibers to form a composite with a nonwoven fabric substrate. As mentioned above, electrospinning can provide microfibers by applying a high voltage between the spinning nozzles and the counter electrode. And if a nonwoven fabric substrate is placed therebetween, microfibers can be deposited on the substrate surface, thereby a composite fiber agglomerate can be readily prepared. This method can be applied to form a composite of polymers having different properties.

However, electrospinning has great disadvantages in industrial-scale productivity. More specifically, the production volume of microfibers is proportionate to the number of spinning nozzles, so there is a limitation in the technical challenge of how the number of nozzles per unit area can be increased. Another problem is that since respective spinning nozzles do not output a constant amount of polymers, the deposits of fibers vary as well.

Moreover, long-term continuous production causes a phenomenon where unspun polymers deposit on the tips of the spinning nozzles and clog the spinning nozzles. Therefore, continuous production is hard to be achieved, and the production lines need to be stopped to clean the spinning nozzles, thereby significantly reducing the productivity.

To overcome these disadvantages of electrospinning, attempts have been made to ensure stable productivity by contriving the number of spinning nozzles and their arrangement. For example, such attempts are disclosed by Japanese Patent Laid-Open No. 2002-201559 and Japanese National Publication No. 2005-534828 of International Patent Application. In both cases, however, polymer solution drops from spinning nozzles onto the fiber agglomerate and the uniformity of the fiber agglomerate is likely to be lost.

Moreover, the problem in production derived from the use of nozzles is the occurrence of corona discharge. The electric field is concentrated on the tip of each nozzle, wherein corona discharge is likely to occur at or below the breakdown voltage of air under atmospheric pressure. Under the occurrence of corona discharge, application of a high voltage to the tip of the nozzle is difficult. In this case, electric charges are not sufficiently accumulated in the polymer solution in the nozzle, microfibers are unlikely to be produced.

Electrospinning under reduced pressure is proposed as a method of preventing the occurrence of such corona discharge. For example, Ratthapol Rangkupan and Darrell H. Reneker disclose such a method in “Development of Electrospinning from Molten Polymers in vacuum,” available on the Internet at the URL: http://www.tx.ncsu.edu/jtatmvolumelspecialissue/posters/posters_partl.pdf. This method reduces the pressure around the nozzles to increase the breakdown voltage, prevent the occurrence of corona discharge, and efficiently accumulate electric charges. In the method, however, for the purpose of maintaining the vacuum, batch production is unavoidable and production is hard to be continuously performed.

Since these problems in productivity of electrospinning come from the use of spinning nozzles, nozzle-free electrospinning has also been studied. For example, such a method is disclosed by A. L. Yarin and E. Zussman in “Upward needleless electrospinning of multiple nanofibers,” Polymer 45 (2004) 2977-2980. This method uses a magnetic fluid as an electrode and performs electrospinning from the surface of a polymer solution. The method uses no spinning nozzles and can realize easy-to-maintain spinning and improve the spinning speed dramatically. In this method, however, the state of spinning is so unstable that the counter electrode needs to have a special structure (saw-toothed), and a fiber agglomerate is difficult to be obtained.

Electrospinning using a rotating roller has been proposed as another spinning method that uses no nozzles. For example, such a method is disclosed on the Internet at the URL: http://www.nanospider.cz/. In this method, electrospinning is performed by immersing a rotating roller in a bath filled with a polymer solution, depositing the polymer solution on the roller surface and then applying a high voltage to the surface. This method is revolutionary in terms of improvement in productivity and ease of maintenance compared with the conventional electrospinning using nozzles. However, the area of the rotating roller portion used for spinning is limited to a certain area on the roller surface, so it is necessary to enlarge the diameter of the rotating roller or increase the number of rotating rollers in order to further improve spinning density and productivity. Therefore, another problem that higher production would require larger-sized production facility is invited. More specifically, the problem of this production system is that, in respect of the area of the bath filled with a polymer solution in which the rotating roller is immersed, the area of the rotating roller surface actually used for microfiber spinning is very small and therefore the production facility as a whole must be enlarged for higher productivity. As mentioned above, no method of obtaining a microfiber assembly or agglomerate by electrospinning that provides ease of maintenance and high productivity has yet been established.

### SUMMARY OF THE INVENTION

It is hence an object of the present invention to provide a process for producing a fiber agglomerate with micropores such as for battery separators and various filters by electrostatic spinning or electrospinning that provides high productivity and ease of maintenance.

To achieve the object, the present invention takes the technical measures described below.

The process for producing a microfiber agglomerate according to the present invention involves electrospinning by continuously forming bubbles on a polymer solution or a polymer melt and applying a high voltage to the formed bubbles.

The bubbles can be generated by passing compressed air through a porous material made of one or a combination of two or more selected from plastics, ceramics, and metal materials or through capillaries.

In addition, the pressure of the compressed air supplied to the porous material or the capillaries can be higher than the pressure P given by the equation below.

P=4×γ×cos θ/D

where γ is the surface pressure of the polymer solution or the polymer melt, θ is the contact angle between the porous material or the capillaries and the polymer solution or the polymer melt, and D is the maximum pore diameter of the porous material or the maximum diameter of the capillaries.

The contact angle according to the present invention refers to the angle which the tangent to the droplet resting on the surface of a solid makes with the solid surface.

The process for producing a microfiber agglomerate according to the present invention is constituted as stated above, forms microfibers from the surface of bubbles by making use of the following nature; in the bubbles generated on the surface of a polymer solution or a polymer melt, chain polymers to form fibers are converted into very thin film in which the physical and chemical intermolecular forces reduces and the polymers tend to disperse into fibers in an electrostatic field. For this reason, unlike the conventional electrospinning using nozzles, there is no need to stop spinning equipment because of nozzle clogging. Therefore, spinning equipment is extremely easy to be maintained.

In addition, since the microfibers are generated on the surface of the bubbles which are formed on the whole of the polymer solution or the polymer melt, the microfibers are spun from the whole of the polymer solution or the polymer melt, the method of the present invention provides significantly higher productivity than the conventional electrospinning using nozzles and electrospinning using a rotating roller.

### BRIEF DESCRIPTION OF THE DRAWING

FIG. 1 is an illustration of the production process of the examples according to the present invention.

### DETAILED DESCRIPTION OF THE INVENTION

Unlike the electrospinning processes conventionally proposed, the present invention provides a process for producing a microfiber agglomerate that is improved in productivity and ease of maintenance and has never been achieved before. According to the present invention, when electrospinning is performed, bubbles are continuously generated on a polymer solution or a polymer melt and a high voltage is applied to the bubbles to form microfibers. At this time, since the microfibers are generated from the surface of the bubbles, they are generated from the whole surface of the polymer solution or the polymer melt. Therefore, the present invention can provide a very productive production process.

Effective methods of forming bubbles on a polymer solution or a polymer melt include a method of passing compressed air through a porous material and a method of passing compressed air through capillaries. The porous material or the capillaries used here are not particularly limited if they have enough pores to form bubbles, are made of material ensuring resistance to the polymer solution or the polymer melt, and have a structure that can withstand the pressure of the compressed air. Therefore, material made of one or a combination of two or more selected from plastics, ceramics, and metal materials can be selected. In addition, the porous material can be used in various aspects of forms such as film form, sheet form, and block form.

The pressure of compressed air supplied to the porous material or capillaries depends on the maximum diameter of pores present in the porous material or the capillaries. In other words, the compressed air having a pressure equal to or greater than that required to pass the compressed air through a porous material or capillaries with the maximum pore diameter and form bubbles must be supplied. It is desirable that this pressure of compressed air be higher than the pressure P given by the equation below.

P=4×γ×cos θ/D

where γ is the surface tension of the polymer solution or the polymer melt, θ is the contact angle which the polymer solution or the polymer melt makes with the porous material or the capillaries, and D is the maximum pore diameter of the porous material or the maximum diameter of the capillaries.

The process for producing a micro fiber agglomerate according to the present invention performs electrospinning from the surface of bubbles formed on the surface of the polymer solution or the polymer melt. To perform this spinning efficiently, formation and breakage of bubbles need to be repeated efficiently. Therefore, it is important to constantly supply compressed air having a pressure equal to or higher than the pressure given by the equation above.

As long as a polymer can be converted into a solution or a melt, any polymer can be used without particular limitations as a polymer that can be spun according to the present invention. Examples of such a polymer include polyvinyl alcohol, polyethylene-vinyl alcohol, polyethylene glycol, polyvinylpyrrolidone, poly-ε-caprolactone, polyacrylonitrile, polylactic acid, polycarbonate, polyamide, polyimide, polyethylene, polypropylene, and polyethylene terephthalate. These can be used alone or in a combination of two or more.

As a solvent used to convert a polymer into a solution, any solvent can be used without particular limitations as long as the solvent completely dissolves the polymer and prevents reprecipitation of the polymer components from the polymer solution during electrospinning. Examples of such a solvent include N,N-dimethylformamide, dimethyl sulfoxide, N-methyl-2-pyrrolidone, tetrahydrofuran, acetone, acetonitrile, 2-propanol, and water. These can be used alone as well as in a combination of two or more.

The concentration of polymer of a polymer solution is not particularly limited as long as the solution has enough viscosity to maintain continuous formation and breakage of bubbles by compressed air, but about 0.5 wt % to 40 wt % is preferable.

The voltage applied to the polymer solution or the polymer melt during electrospinning is not particularly limited if the voltage can maintain continuous spinning. Typically the range of 0.5 to 50 kV is preferably used.

Any gap between the bubbles and the counter electrode during spinning can be selected as needed without particular limitations if the gap can maintain the structure of a microfiber agglomerate produced by spinning. If this gap is too narrow, water droplets from bubbles formed by compressed air stick to a microfiber agglomerate deposited on the counter electrode, and the fiber structure is likely to be broken. In contrast, if the gap is too wide, microfibers are not formed efficiently and a fiber agglomerate is hard to be produced. The preferable gap between the surface of the bubbles and the counter electrode is 3 to 15 cm.

Although examples according to the present invention shown in Table 1 are described below, the invention is not limited thereto. The pressure P given by the equation mentioned earlier corresponds to the “First bubble pressure” in Table 1.

TABLE 1

| | | | Polymer | Porous material for bubble formation | | | Compressed | Spinning |
|---|---|---|---|---|---|---|---|---|
| | | | content | Brand | Max. pore | First bubble | air pressure | capacity |
| | Polymer | Solvent | Mass % | name* | diameter (μm) | pressure (kPa) | kPa | g/(h · m²) |
| Example 1 | Polyvinyl alcohol | Water | 20 | 15TH145 | 60 | 3.7 | 4.0 | 92 |
| Example 2 | | | | | | | 5.0 | 207 |
| Example 3 | | | | | | | 6.0 | 438 |
| Example 4 | | | 30 | | | 4.1 | 4.5 | 370 |
| Example 5 | | | | | | | 5.0 | 454 |
| Example 6 | | | | | | | 6.0 | 263 |
| Example 7 | | | 20 | 15TH14 | 449 | 0.9 | 1.0 | 56 |
| Example 8 | | | | 15TH24 | 256 | 1.5 | 2.0 | 275 |
| Example 9 | Poly-ε-caprolactone | Acetone | 5 | 15TH145 | 60 | 2.1 | 2.5 | 199 |
| Example 10 | | | | | | | 3.0 | 338 |
| Example 11 | Polyvinylpyrrolidone | 2-Propanol | 30 | 15TH145 | 60 | 2.6 | 3.0 | 298 |
| Example 12 | | | | | | | 4.0 | 1,651 |
| Example 13 | | | | | | | 5.0 | 2,129 |
| Comparative | Polyvinyl alcohol | Water | 20 | 15TH145 | 60 | 3.7 | 3.0 | 0 |
| Example 1 | | | | | | | | |
| Com. Ex. 2 | | | 30 | | | 4.1 | 4.0 | 0 |
| Com. Ex. 3 | | | 20 | 15TH14 | 449 | 0.9 | 0.5 | 0 |
| Com. Ex. 4 | | | | 15TH24 | 256 | 1.5 | 1.0 | 0 |
| Com. Ex. 5 | Poly-ε-caprolactone | Acetone | 5 | 15TH145 | 60 | 2.1 | 2.0 | 0 |
| Com. Ex. 6 | Polyvinylpyrrolidone | 2-Propanol | 30 | | | 2.6 | 2.5 | 0 |

*Nonwoven fabrics from Hirose Seishi Kabushiki Kaisha

### Example 1

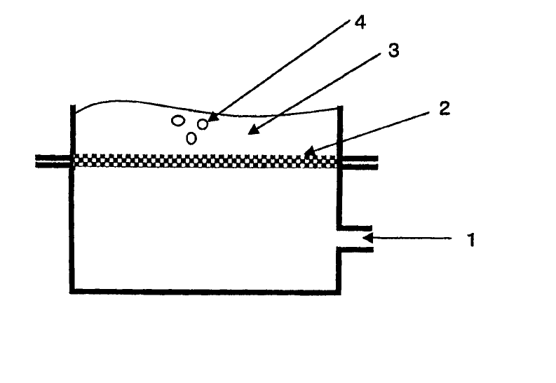

Polyvinyl alcohol having a degree of saponification of 87.0 to 89.0 mol % was dissolved in water to prepare a polymer solution (aqueous spinning solution) having a solid concentration of 20 mass %. As shown in FIG. 1, this polymer solution 3 was put in an 80-mm diameter stainless steel cylindrical container, and an unwoven fabric 2 (unwoven fabric from Hirose Seishi Kabushiki Kaisha; brand name, 15TH145) was placed as a porous material for bubble formation so that compressed air 1 could be supplied from the bottom surface. Compressed air having a pressure of 4.0 kPa was supplied through the unwoven fabric 2 to continuously form bubbles 4 on the whole surface of the polymer solution. As the counter electrode, an aluminum foil was placed 8 cm away from the bubble surface (not shown). Once bubbles have been formed uniformly on the polymer solution, a high DC voltage of 40 kV was applied to the polymer solution side to form a microfiber agglomerate on the aluminum foil. Electrospinning was performed for 3 minutes while the compressed air was continuously supplied, and then the microfiber agglomerate deposited on the aluminum foil was weighed. The calculated weight of the spun fibers per unit area per unit time was 92 g/(h·m²).

### Examples 2 to 8

Under the conditions shown in Table 1, the concentration of polyvinyl alcohol having a degree of saponification of 87.0 to 89.0 mol % was prepared, and the porous material for bubble formation and the compressed air pressure were varied. Spinning was performed as in Example 1, and the spun fibers of the microfiber agglomerates were weighed. Results are shown in Table 1. It was found that as the compressed air pressure increased, the weight of the spun fibers increased.

### Examples 9 to 10

Poly-ε-caprolactone having a weight-average molecular weight of 80,000 was dissolved in acetone to prepare a polymer solution having a solid concentration of 5 mass %. The porous material for bubble formation and the compressed air pressure were varied as shown in Table 1, and then spinning was performed as in Example 1, and the spun fibers of the microfiber agglomerates were weighed. Results are shown in Table 1. It was found that as the compressed air pressure increased, the weight of the spun fibers increased.

### Examples 11 to 13

Polyvinylpyrrolidone having a weight-average molecular weight of 40,000 was dissolved in 2-propanol to prepare a polymer solution having a solid concentration of 30 mass %. The porous material for bubble formation and the compressed air pressure were varied as shown in Table 1, then spinning was performed as in Example 1, and the spun fibers of the microfiber agglomerates were weighed. Results are shown in Table 1. It was found that as the compressed air pressure increased, the weight of the spun fibers increased.

As mentioned above, the formation of microfiber agglomerate was confirmed in each Example. The process for producing a microfiber agglomerate according to the present invention can also be performed as a modification of the conventional nozzle process or cylinder process. For example, in the nozzle process, each nozzle is equipped with an attachment to form air bubbles at its tip and spinning can be performed. In this case, productivity can be significantly improved by maintaining the balance between the supply of the polymer solution or the polymer melt and the speed of fiber formation. In the cylinder process, film may be made thin by gas, stretching, and the like.

### Comparative Examples 1 to 6

Under the conditions shown in Table 1, each polymer solution was prepared, and the compressed air pressure was maintained at or below the first bubble pressure for the porous material for bubble formation. Spinning was performed as in Example 1, and the spun fibers of the microfiber agglomerates were weighed. Results are shown in Table 1. If the compressed air pressure was equal to or lower than the first bubble pressure, no bubbles were formed and thus spinning was not performed, so the weight of the spun fibers of the microfiber agglomerate was zero.

What is claimed is:

1. Process of producing a micro fiber agglomerate by electrospinning comprising: continuously forming bubbles on one of a polymer solution and a polymer melt, and applying high voltage to the bubbles.

2. The process of producing a microfiber agglomerate according to claim 1 wherein the continuous bubble formation on one of the polymer solution and the polymer melt is performed by passing compressed air through one of a porous material of one or a combination of two or more selected from plastics, ceramics and metal materials and capillaries.

3. The process of producing a microfiber agglomerate according to claim 2 wherein the compressed air pressure to be supplied to one of the porous material and the capillaries is higher than the pressure given by the equation below:
P=4×γ×cos θ/D
where γ is a surface pressure of one of the polymer solution and the polymer melt, θ is a contact angle between one of the porous material and the capillaries and one of the polymer solution and the polymer melt, and D is one of a maximum pore diameter of the porous material and a maximum diameter of the capillaries.
